(19) United States
(12) Patent Application Publication
(10) Pub. No.: US 2025/0208305 A1
(43) Pub. Date: Jun. 26, 2025

(54) METHOD FOR THE UNSUPERVISED CALIBRATION OF A DETECTOR

(71) Applicant: COMMISSARIAT A L'ENERGIE ATOMIQUE ET AUX ENERGIES ALTERNATIVES, Paris (FR)

(72) Inventors: Guillaume MONTEMONT, Grenoble Cedex 09 (FR); Alexandre DELCOURT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/987,317

(22) Filed: Dec. 19, 2024

(30) Foreign Application Priority Data
Dec. 20, 2023 (FR) FR2314679

(51) Int. Cl. G01T 1/24; G01T 7/00

(52) U.S. Cl. CPC G01T 1/241; G01T 7/005

(57) ABSTRACT

A method for determining parameters governing the transport properties of charge carriers in an ionising radiation detector. The method involves irradiating the detector and simulating a propagation of charge carrier clouds towards electrodes of the detector, so as to compare the signal resulting from the simulation and the measured signal. This allows an error to be defined, which error is backpropagated to the site of the interaction in the detector. During the backpropagation, the transport parameters of the charge carriers are updated, so as to minimise the error. The propagation/backpropagation operation is iterative and continues until a stop criterion for stopping the iterations is met.

### TECHNICAL FIELD

The technical field of the invention is the calibration of ionising radiation detectors, for example, X-ray or gamma-ray radiation, and in particular for spectrometric imaging.

### PRIOR ART

Gamma cameras are devices for forming an image in order to establish a map of irradiating sources in a given environment, and in particular in nuclear installations, for medical diagnostic applications, or even for applications of the non-destructive testing type, for example, baggage screening.

Some gamma cameras are made up of a two-dimensional matrix of pixels connected to a detector material. The detector material is generally a semiconductor material, for example, CdTe or CdZnTe. When ionising radiation interacts with the detector material, one or more pixels generate an electric pulse, the amplitude of which correlates with the energy released by the radiation during the interaction. Each pixel is connected to an electronic pulse processing circuit.

Each pixel is made up of an electrode, which usually acts as an anode. When incident radiation interacts with the detector material, electrons are released into the detector material. The electrons are collected by an anode. The anode generates a pulse whose amplitude depends on the number of electrons collected by the anode, with this number generally being proportional to the energy lost by the ionising radiation in the detector material.

Each detector extends over a few hundred square millimetres. For the sake of compactness, the pixel matrix generally comprises one hundred, or a few hundred, pixels per row and per column.

CdZnTe, or CZT, is often used as a detection material in gamma cameras. Indeed, this material combines numerous advantages for use in imaging high-energy X-rays or gamma-rays:
a high-Z atomic number and a high density for an advantageous incident photon absorption power;
a band gap that is wide enough to be used at room temperature, while being limited in order to maintain low enough energy for creating Epair electron-hole pairs;
advantageous charge transport properties (lifetime T and carrier mobility u) in order to have an average free path μT that is as high as possible.

A considerable amount of work has been carried out over the years to improve the composition, crystal growth, geometry and processing electronics concerning these detectors in order to optimise their performance capabilities.

However, the main difficulty in using CZT is the presence of various types of defects in the crystal lattice, which modify the properties of the material and thus affect the output signals of the detector. These defects can assume different types and sizes: Cd vacancies on an atomic scale, or grain sub-joints that can be several cm long. These defects, which appear during the growth of CZT crystals, hinder the development of larger-volume detectors and generally degrade their performance capabilities by producing a non-uniform response that varies from one pixel to another.

These defects cause intermediate energy states to appear in the band gap. When a carrier is in one of these new energy states, it can either recombine or return to its initial state. The trapped carriers create space charges, which modify the electric field inside the detector. The trapping is non-uniform and affects the uniformity of the electric field.

Indeed, these defects result in an error in the signals induced by the charge carriers and therefore in the signals collected on the electrodes, which disrupts the current measured at the output, which is used as data for locating the source with the most accurate resolutions possible.

Until now, the responses of the detector can be learnt by using supervised algorithms, such as maximum likelihood algorithms or neural networks. However, this assumes that precise data is available for each individual detector. Indeed, defects affect each detector differently. Thus, implementing a supervised algorithm therefore requires the availability of reliable data concerning the position of interactions in the detector and the energy deposited during each interaction. This implies, for example, scanning a detector using a fine photon beam, preferably monoenergetic. Such a scan is hardly feasible for systematically characterising detectors when they are manufactured.

The inventors propose a solution allowing unsupervised learning to be carried out, so as to learn the response function of a detector, based on relatively unrestrictive irradiation thereof. “Relatively unrestrictive” is understood to mean irradiation that is not necessarily collimated. The whole detector can be irradiated, so as to learn the response of the assembly formed by the detector material and the electrodes. This involves allowing precise simulations to be carried out of the signals detected by the detector, taking into account any defects inherent in the use of a CdZnTe type detection material.

### DISCLOSURE OF THE INVENTION

A first aim of the invention is a method for estimating a signal measured on a pixel of a detector, the detector comprising a plurality of electrodes, forming pixels, connected to a detector material, the detector material being a semiconductor, each electrode being configured to collect charge carriers moving, through the detector material, under the effect of an electric field, following an interaction of an X-ray or gamma-ray photon in the detector material, the method comprising:
irradiating the detector with X-ray or gamma-ray photons, so as to generate interactions in the detector material, with each interaction forming a detection signal measured by at least one electrode;
associating, for various detected interactions, a state vector, comprising at least a position, a charge, and each detection signal, with the state vector transitioning from an initial state, when the interaction occurs, to a final state, when the electrons generated by the interaction are collected by at least one electrode;
   wherein the method comprises, for each detected interaction:
(i) initialising the initial state vector;
(ii) implementing, based on the initial state vector, or on an initial state resulting from a previous iteration, a charge carrier propagation model in the semiconductor material, in order to estimate the final state vector, with the propagation model being based on a parameter vector, parameterising at least one transport property of the charge carriers through the detector material, towards the electrodes;
(iii) computing an error, representing a difference between the estimated detection signal in the final state vector and the measured detection signal;
(iv) backpropagating a gradient of the error from the final state to the initial state, with the gradient of the error being computed relative to at least one term of the state vector, and relative to a plurality of parameters of the parameter vector;
(v) updating the state vector, at the initial instant, and the parameter vector, and repeating steps (ii) to (v) until a criterion for stopping the iterations is met; And wherein steps (i) to (v) are implemented by a processing unit connected to the detector.

According to one possible embodiment, the detector material is discretised into voxels, and the parameter vector comprises, for each voxel, a transport property for the charge carriers in the detector.

According to one possible embodiment, the transport property for charge carriers comprises:
a value of the electric field; and/or
a gradient of the electric field in at least one direction; and/or
a value of a divergence of the electric field; and/or
a probability of trapping in the voxel.

According to one possible embodiment:
steps (i) to (v) are implemented for various interactions, so as to update the parameter vector each time steps (i) to (v) are implemented;
the parameter vector is then updated by combining the parameter vectors updated during each interaction.

According to one possible embodiment:
for each interaction, the time between the initial state and the final state is discretised into time steps;
step (ii) comprises a digital integration of an evolution function, with the evolution function translating a temporal evolution of the position and of the charge of the charge carriers, as well as an evolution of each detection signal, with the digital integration being successively carried out between each time step, between the initial state and the final state.

Step (iv) can comprise a digital integration of an adjoint propagation equation, translating a temporal evolution of the gradient of the error, with the digital integration being successively carried out between each time step, between the final state and the initial state.

A second aim of the invention is a method for learning a supervised artificial intelligence algorithm, intended to simulate a response of a detector, the detector comprising a plurality of electrodes, forming pixels, connected to a semiconductor material, each pixel being configured to collect charge carriers moving, through the semiconductor material, under the effect of an electric field, following an interaction of an X-ray or gamma-ray photon in the semiconductor material, the method comprising the following steps of:
a) defining a position of an interaction in the detector and energy released during said interaction;
b) estimating a detection signal measured by at least one electrode of the detector, by implementing the steps of a method according to the first aim of the invention;
c) repeating steps a) and b) so as to form a database connecting, for each defined interaction, the measured signal to at least one pixel;
d) using the database to carry out supervised learning of the artificial intelligence algorithm.

The artificial intelligence algorithm can be of the multilayer perceptron type.

A third aim of the invention is a detector, comprising a plurality of electrodes, forming pixels, connected to a semiconductor material, with each pixel being configured to collect charge carriers moving, through the semiconductor material, under the effect of an electric field, following an interaction of an X-ray or gamma-ray photon in the semiconductor material, with the detector being connected to a processing unit configured to implement steps (i) to (v) of a method according to the first aim of the invention.

A fourth aim of the invention is a detector, comprising a plurality of electrodes, forming pixels, connected to a semiconductor material, with each pixel being configured to collect charge carriers moving, through the semiconductor material, under the effect of an electric field, following an interaction of an X-ray or gamma-ray photon in the semiconductor material, with the detector being connected to a processing unit configured to estimate energy released by the interaction and/or a position of the interaction, with the processing unit implementing a supervised artificial intelligence algorithm that is learnt according to the second aim of the invention.

### DRAWINGS

The invention will be better understood upon reading the disclosure of the embodiments provided throughout the remainder of the description, with reference to the following figures, in which:

FIG. 1 schematically shows a detector;

FIG. 2A shows the main steps of a method for determining a response from a detector;

FIG. 2B illustrates the steps discussed in relation to FIG. 2A;

FIGS. 2C and 2D show how five or nine anodes are taken into account for determining a collected charge;

FIG. 3 shows some of the operations described in relation to FIG. 2;

FIGS. 4A to 4H show the performance capabilities of estimating the depth of interaction implementing the invention, during successive iterations;

FIG. 5A shows a comparison between an estimate of interaction positions implementing the invention and measured interaction positions;

FIG. 5B shows a comparison between an estimate of depths of interaction implementing the invention, and the measured depths of interaction;

FIGS. 5C and 5D correspond to FIGS. 5A and 5B, respectively, with noise taken into account;

FIG. 6A shows a measured map of a “CIE” quantity, which corresponds to a ratio between the collected charge and the deposited charge;

FIG. 6B shows an estimated map of the CIE implementing the method.

### DISCLOSURE OF PARTICULAR EMBODIMENTS

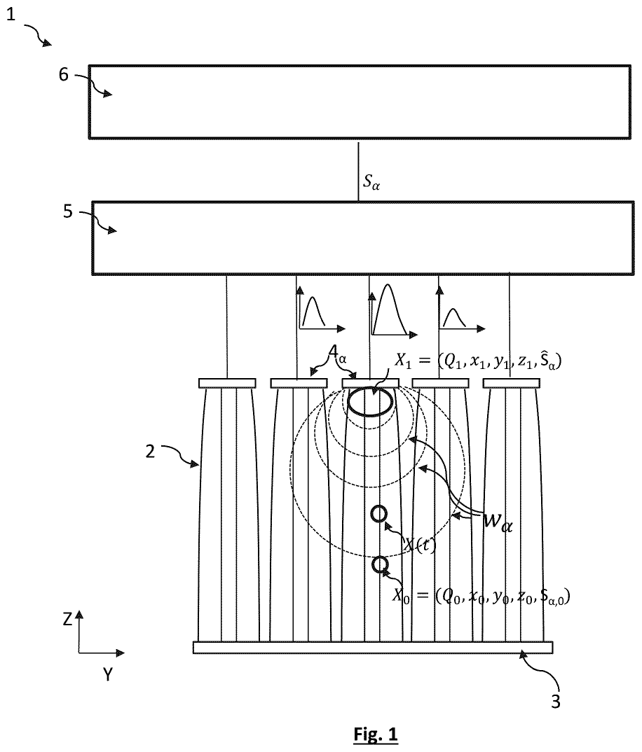

FIG. 1 schematically shows a structure of a detector 1. The detector comprises a detector material 2, polarised between a cathode 3 and various anodes 4. The anodes are connected to a readout circuit 5, allowing each detection signal formed on each anode to be analysed.

An interaction in the detector material creates charge carriers: the electrons migrate towards the anodes, while the holes migrate towards the cathode. In a semiconductor such as CZT, the differences in transport properties between the electrons and the holes mean that using the electron signal is much more advantageous in terms of the performance capabilities of the detector. Throughout the remainder of the description, only the transportation of electrons through the detector is taken into account, on the understanding that the invention also can be applied to other types of charge carriers, such as holes, for example. Each interaction results in the formation of an electron cloud, migrating towards one or more anodes.

Each anode forms a pixel, allowing a detection signal to be measured following each interaction. During an interaction, one or more anodes detect a pulse. A detection signal Sa is formed from each pulse, allowing the interaction to be located in the detector material. The detection signal can comprise one or more features of the detected pulse, as described in document U.S. Pat. No. 9,322,937. The index a designates each anode that has received a usable detection signal. The number of anodes that have received a usable detection signal can vary between 1 and 9, or even more, as described hereafter. For each interaction, there is an initial instant to, corresponding to the occurrence of the interaction, and an instant t₁, corresponding to the collection of electrons by one or more anodes.

The collected charge Q₁, reaching the anodes, is used to estimate the charge Q₀ deposited in the detector material during the interaction. Each interaction can be assigned a state X of the charge carriers generated by the interaction, which varies between an initial state X₀, when the interaction occurs, and a final state X₁, corresponding to the collection of charges by the anodes. The initial state X_{θ} is characterised by the quantities (Q₀, x₀, y₀, Z₀, S_{α,0}), corresponding to the charge released by the photon in the detector, the position of the interaction and the signal induced on the electrodes during the interaction. The final state X₁ is characterised by the quantities (Q₁, Z₁, X₁, y₁, S_{α,1}), corresponding to the charge collected on the anodes and the position of a centroid of the charge carrier cloud reaching the electrodes, as well as to the signal induced on each electrode, which can be measured.

FIG. 1 shows the field lines along which the charge carriers generated during the interaction propagate between the initial state X₀, an intermediate state X(t) and the final state X₁. One or more signals S_{α} is/are detected for each interaction. Each charge carrier propagates through the detector according to transport properties p(r) that characterise the detector. In this example, the detector is made of CdZnTe: therefore, the charge carriers are electrons. Alternatively, the charge carriers can be holes.

Each voxel is assigned a coordinate (x, y, z). Each voxel can be the result of a discretisation of the volume of the detector material with a spatial step of 100 μm in each direction. Each voxel is associated with at least one transport property p(r), for example, a value of the electric field u(r), and/or a trapping probability τ(r), or a feature representing a spatial variation in the electric field, for example, a gradient or divergence of the electric field. For example, each voxel r is assigned a property p(r), corresponding to the pair (u(r), τ(r)), i-e trapping probability and electric field.

The spatial distribution of the transport properties p(r), in each voxel, is parameterised by parameters θₙ, forming a parameter vector θ. According to a first approach, each voxel r is associated with parameters θₙ(r)=p(r)=(u(r), t(r)), defined for each voxel. This assumes that a parameter value is defined for each voxel, which is restrictive in terms of memory size: there are as many parameters as voxels, n is an integer ranging between 1 and N, with N corresponding to the number of determined parameters.

According to another approach, the spatial distribution of the parameters p(r) is parameterised by parameters θₙ applied to a spatial function Fₙ(r) or to a combination of spatial functions. For example, p(r)=Σₙθₙ Fₙ(r).

Each spatial function Fₙ(r) can be, for example, a sinusoidal or polynomial function. The use of spatial functions allows the number of parameters θₙ in the parameter vector θ to be reduced.

To summarise, each voxel is assigned at least one transport property p(r) of a charge carrier. The parameters θₙ are used to define the spatial distribution of the transport properties in the voxels of the detector.

The parameter vector of a detector is unknown, in particular due to the presence of randomly distributed defects in the detector material, which influence the transportation of charges between the interactions and the electrodes that collect the charge carriers, i.e., the anodes in the case of electrons. It forms a signature, conditioning the response of the detector. For each detector, the values of each are considered to be stable over time.

The parameter vector θ allows an evolution function ƒ_{θ} to be established, allowing the state of the cloud of charge carriers generated by the interaction to be monitored, from the initial state to the final state, for each interaction.

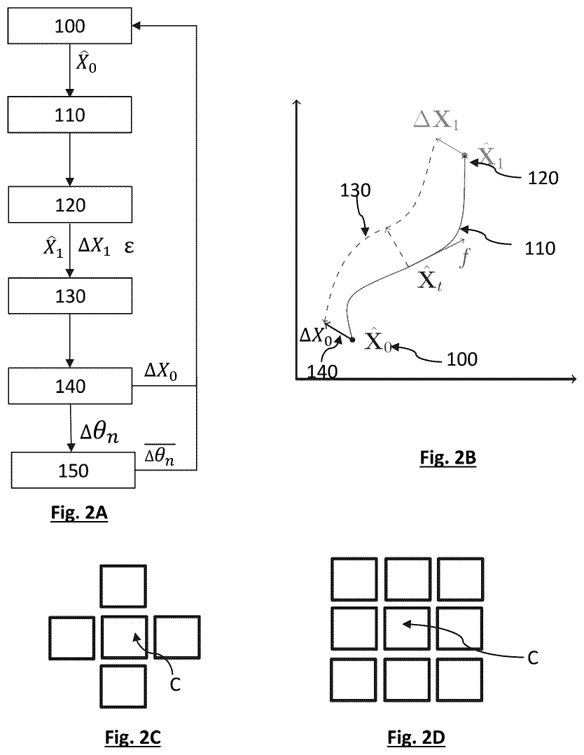

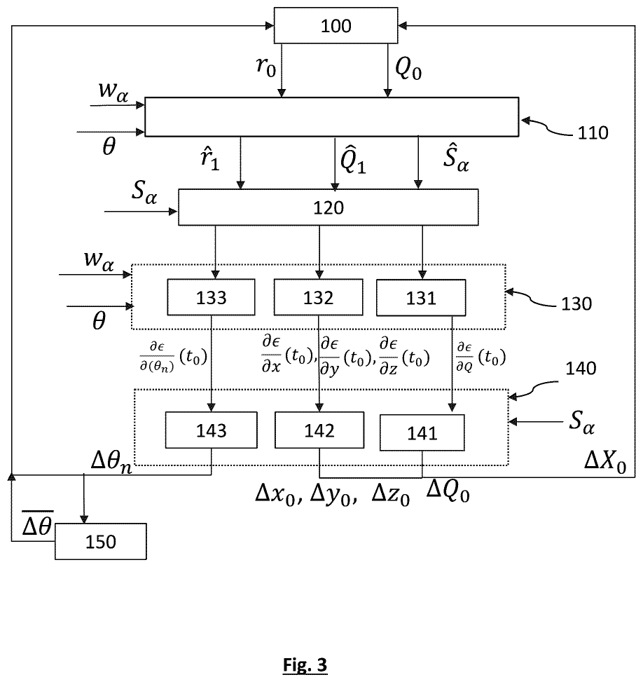

The readout circuit 5 is connected to a processing unit 6, configured to determine the set of parameters from signals S_{α} respectively measured during each interaction, by implementing the steps described with reference to FIGS. 2A and 3. The processing unit 6 notably comprises one or more microprocessors, programmed to implement the steps described hereafter.

FIG. 2A summarises the main steps of a method designed to learn the set of parameters θ governing the transport properties p(r) of the detector. The detector is exposed to an irradiation source, the emission energy or energies of which are known. Under the effect of the irradiation, interactions occur in the detector material 2. During each interaction, a detection signal S_{α} is measured by the anodes. The index a designates each anode detecting a usable signal. The signal S_{α} and a vector formed by each detection signal formed on a single anode or several adjacent anodes, for example:
four anodes: these are the 4 anodes closest to the position of the electron cloud when it reaches the anodes;
five anodes: four electrodes around the anode C that has collected the highest amount of charges, with said anode being the collecting anode;
nine anodes: 8 anodes around the collecting anode.

During irradiation, the detection signals S_{α} measured during irradiation are collected. Each measured signal S_{α} corresponds to a detected interaction. The iterative steps 100 to 150 are implemented for each detected interaction. Each interaction extends between the initial instant to (occurrence of the interaction) and the final instant t₁ (collection of the charges by the anodes) defined beforehand.

Step 100: initialisation: an initialised value of the initial state \hat{X}_{θ} is estimated for each interaction. The position of the interaction can be defined randomly. The deposited energy Q₀ can be determined randomly, or as a function of a maximum amount of energy defined as a function of the nature of the irradiation source.

Step 110: during this step, the state resulting from step 100 or a previous iteration is propagated. This step is implemented using an evolution function ƒ_{θ}, described hereafter, and is parameterised by the parameter vector θ. The evolution function is described by a differential equation of the following type:

$$\frac{d ( X ( t ) )}{d t} = {f}_{θ} ( X ( t ) , t ) \qquad ( 1 )$$

### Thus,

$${\hat{X}}_{1} = {\hat{X}}_{0} + {\int }_{t 0}^{t 1} {f}_{θ} ( X ( t ) ) d t \qquad ( 2 )$$

The integral of the expression (2) can be computed digitally, one step at a time, for example, using a Runge-Kutta method.

Step 120: estimation of the final state \hat{X}₁ and computation of an error. Error computation: during this step, an error function is determined between the estimated final state \hat{X}₁ and the measured final state \hat{X}₁. In the measured final state, an estimate is available of each signal measured on the electrodes, as well as a measurement of this signal.

$$ε = {‖ - {S}_{α} ‖}^{2} ( 3 ) : norm of the error .$$

$$And$$

$$Δ {S}_{α} = {\hat{S}}_{α} - {S}_{α} ( {3}^{′} ) : this is the deviation on the observation .$$

Other expressions for the norm of the error can be contemplated.

Step 130: backpropagation. Based on the deviation ΔX₁ (\hat{X}₁-X₁), a deep learning algorithm of the N-ODE type, as previously mentioned, is implemented in order to obtain an error ΔX₀ with regard to the initial state \hat{X}₀ taken into account during step 100, and in order to update the initial state. This phase, called backpropagation, involves computing the gradients of the error relative to each component of the parameter vector, as well as relative to the components of the state vector (spatial components x, y and z, charges Q, signal or signals S_{α}. The backpropagation is carried out from the final state (instant t₁) to the initial state (instant t₀), given that these instants are known.

Step 140: Deviation computation.

During this step, a deviation ΔX₀ to be applied to the initial state is computed for each interaction, as a correction term, so as to progressively minimise the error ε. A deviation Δθₙ is also determined for each term of the parameter vector. Steps 100 to 140 are then repeated until an iteration stopping criterion is met, for example, a predetermined number of iterations or a threshold value of the error function below which the parameter vector is considered to describe the behaviour of the detector well enough.

Step 150: Consideration of various interactions.

During this step, the parameters θₙ determined for various interactions are considered in order to estimate an average parameter vector θ̅ₙ̅, or another statistical function, so as to allow the parameter vector to be corrected by taking a large number of interactions into account.

FIG. 2B illustrates the main steps of the method.

Steps 110 and 130, which form the basis of the method, will now be described in detail. Step 110 is a propagation phase, aimed at estimating the state \hat{X}₁ from an estimated state \hat{X}₀ by the successive integration of the evolution function according to predetermined time steps.

$$In the final state : {\hat{X}}_{0} = ( {\hat{Q}}_{0} , {\hat{x}}_{0} , {\hat{y}}_{0} , {\hat{z}}_{0} , {S}_{α , 0} ) \qquad ( 4 )$$

$$In the final state : {\hat{X}}_{1} = ( {\hat{Q}}_{1} , {\hat{x}}_{1} , {\hat{y}}_{1} , {\hat{z}}_{1} , {\hat{S}}_{α , 1} = {\hat{S}}_{α} ) \qquad ( 5 )$$

Among the modelling assumptions, the following is considered:
the spatial distribution of electrons in the detector volume follows a spherical Gaussian distribution whose extension is due to Coulomb diffusion and repulsion. The temporal evolution of the variance of this distribution is known, as described in the publication by G. Montemont, S. Lux, O. Monnet, S. Stanchina, and L. Verger entitled, “Studying Spatial Resolution of CZT Detectors Using Sub-Pixel Positioning for SPECT”, IEEE Transactions on Nuclear Science, vol. 61, No. 5, pp. 2559-2566 October 2014, and more specifically in connection with FIG. 2 of this publication;
each primary photon will generate a certain number of secondary electrons depending on its energy, which can themselves generate secondary photons, and so on. The interaction of a photon therefore can be schematically shown as a series of highly localised deposits separated by a significant distance. Each of these deposition positions will generate an electron cloud that will expand under the effect of Coulomb thermal diffusion and repulsion.

The evolution function is such that:

$${f}_{θ} = \frac{d}{d t} \{ \begin{matrix}Q \\ \vec{r} \\ {S}_{α}\end{matrix} = \{ \begin{matrix}\frac{− Q}{τ} \\ \vec{u} \\ Q ( {\vec{w}}^{α} \cdot \vec{u} )\end{matrix} = \{ \begin{matrix}\frac{− Q}{τ} \\ {u}^{i} \\ {\sum }_{i} {Qw}_{i}^{α} {u}^{i}\end{matrix} \qquad ( 6 )$$

where:
\vec{r} is the position of the centroid of the carrier cloud. It depends on the time \vec{r}=\vec{r}(t). The various terms \vec{r}(t) represent a trajectory of the charge carrier cloud;
\vec{=}=μ\vec{E} corresponds to the speed of the electrons in the detector material and \vec{E} is the electric field; \vec{u} and \vec{E} are voxelised data: \vec{u}=(\vec{r}); \vec{E}=\vec{E}(\vec{r});
τ is the lifetime of the electrons in the detector material: this is a spatially distributed quantity in the detector, therefore, τ=τ(\vec{r});
Q is the total charge of the electron cloud: this is the charge integral of the charge carrier cloud at a time t, Q=Q(t). This charge changes as a function of carrier trapping;
S_{α} is the signal of each anode of rank a;
i=is the index of the spatial coordinates: i=1, 2 and 3 respectively correspond to the spatial coordinates x, y and z;
\vec{w} is the weighting field of the detector, which corresponds to the gradient of the weighting potential. \vec{w} is discretised on each anode, with each anode corresponding to a vector \vec{w}_{α} whose values \vec{w}_{α}(\vec{r}) are defined for each voxel of the detector. FIG. 1 schematically shows the weighting field of an anode. Each dashed curve corresponds to identical values of the weighting field.

The weighting potential is used to compute the signal collected by an anode under the effect of a moving charge in the detector material. The weighting potential does not have a physical unit and represents the influence of an anode on signal induction as a function of the distance to the moving charged particle. The weighting potential is significant in the vicinity of each anode: in the vicinity of each anode, electrons are subjected to the weighting potential, by which a detection signal is formed as a result of the movement of the electrons. The weighting potential is considered to be invariant from one anode to another: it depends on the size of each anode, the space between two adjacent anodes and the thickness and permittivity of the detector material.

The spatial gradient of the weighting potential forms a weighting field in the vicinity of an anode. The value of the current collected on the anode depends on the scalar product of the weighting field and on the electric field extending through the detector material.

Thus, at an instant t, when the electron cloud extends along a coordinate \vec{r}(t)=(x, y, z) in the detector, it induces, on each anode α, a signal S_{α}(t), such that:

$$\frac{d {S}_{α} ( t )}{d t} = Q ( t ) \vec{u} ( \vec{r} ) \cdot {\vec{w}}_{α} ( \vec{r} ) d t$$

Equation (6) corresponds to the temporal transport equation, allowing the drift of the electron cloud to be simulated in the detector, so as to estimate \hat{X}₁ based on \hat{X}₀-ƒ_{θ} is the temporal evolution function (or propagation function). The drift of the electron cloud is obtained in predetermined time increments, for example, 1 ns or a few ns, on the understanding that, given the usual dimensions of a detector, the propagation time between interaction and detection is a few tens of μs.

The propagation step involves a digital integration, one step at a time, of the following type:

$$\hat{X} ( T + d t ) = \hat{X} ( T ) + {\int }_{T}^{T + d t} {f}_{θ} ( t ) dt \qquad ( 9 )$$

This allows the evolution of the state of the electron cloud to be estimated between the initial and final instants t₀ and t₁, given that the latter are known. The integration can implement a Runge-Kutta integration method, for example.

This allows an estimate to be obtained of \hat{X}(t₁)= [symbol]
an estimate of the position \hat{r}₁;
an estimate of the charge \hat{Q}₁;
an estimate of the detected detection signal [symbol] , given that the measured detection signal S_{α} is known.

### Backpropagation

Backpropagation is the subject of sub-steps 131 to 133 of step 130.

Step 130 corresponds to a backpropagation of the term

$${X}^{⋆} = \frac{\partial ϵ}{\partial {X}^{′}}$$

for each interaction, between the final state (X=X₁), resulting from the measurements of S_{α}, and the initial state (X=X₀). This involves carrying out a backpropagation, one step at a time, of the errors

$${r}^{⋆} = \frac{\partial ϵ}{\partial r} , {Q}^{⋆} = \frac{\partial ϵ}{\partial Q} and {θ}^{⋆} = \frac{\partial ϵ}{\partial θ}$$

relative to the position of the electron cloud and the charge, respectively, between r=r₁, r=r₀ and Q=Q₁, Q=Q₀, respectively. The charge Q* is backpropagated according to expression (20).

The backpropagation of the error r* is carried out according to expressions (30) to (32).

The backpropagation of the error θ* relative to the parameter vector is carried out according to expression (40).

$$Let \hat{X} ( T − d t ) = \hat{X} ( T ) − {\int }_{T − d t}^{T} {f}_{θ} ( t ) dt$$

In general, if

$${X}^{⋆} = \frac{\partial ϵ}{\partial X} ,$$

with ϵ=∥ΔX∥²

$$( 10 )$$

$${\dot{X}}^{⋆} = \frac{d}{d t} \{ \begin{matrix}\frac{\partial ϵ}{\partial Q} \\ \frac{\partial ϵ}{\partial r} = \frac{d}{d t} \{ \begin{matrix}\begin{matrix}{Q}^{⋆} \\ {\vec{r}}^{⋆}\end{matrix} \\ {θ}^{⋆}\end{matrix} = \\ \frac{\partial ϵ}{\partial θ}\end{matrix} [ \begin{matrix}\frac{− 1}{τ} & 0 & 0 & 0 & \vec{u} \cdot \vec{{w}^{1}} \\ 0 & \frac{\partial {u}_{x}}{\partial x} & \frac{\partial {u}_{y}}{\partial x} & \frac{\partial {u}_{z}}{\partial x} & Q \frac{\partial ( \vec{u} \cdot \vec{{w}^{1}} )}{\partial x} \\ 0 & \frac{\partial {u}_{x}}{\partial y} & \frac{\partial {u}_{y}}{\partial y} & \frac{\partial {u}_{z}}{\partial y} & Q \frac{\partial ( \vec{u} \cdot \vec{{w}^{1}} )}{\partial y} \\ 0 & \frac{\partial {u}_{z}}{\partial z} & \frac{\partial {u}_{y}}{\partial z} & \frac{\partial {u}_{z}}{\partial z} & Q \frac{\partial ( \vec{u} \cdot \vec{{w}^{1}} )}{\partial z} \\ \frac{Q \partial τ}{{τ}^{2} \partial {θ}_{1}} & \frac{\partial {u}_{x}}{\partial {θ}_{1}} & \frac{\partial {u}_{y}}{\partial {θ}_{1}} & \frac{\partial {u}_{z}}{\partial {θ}_{1}} & Q \frac{\partial \vec{u}}{\partial {θ}_{1}} \cdot \vec{{w}^{1}} \\ ⋮ & ⋮ & ⋮ & ⋮ & ⋮ \\ \frac{Q \partial τ}{{τ}^{2} \partial {θ}_{N}} & \frac{\partial {u}_{x}}{\partial {θ}_{N}} & \frac{\partial {u}_{y}}{\partial {θ}_{N}} & \frac{\partial {u}_{z}}{\partial {θ}_{N}} & Q \frac{\partial \vec{u}}{\partial {θ}_{N}} \cdot \vec{{w}^{1}}\end{matrix} \begin{matrix}\vec{u} \cdot \vec{{w}^{2}} & \vec{u} \cdot \vec{{w}^{3}} & \vec{u} \cdot \vec{{w}^{4}} \\ Q \frac{\partial ( \vec{u} \cdot \vec{{w}^{2}} )}{\partial x} & Q \frac{\partial ( \vec{u} \cdot \vec{{w}^{3}} )}{\partial x} & Q \frac{\partial ( \vec{u} \cdot \vec{{w}^{4}} )}{\partial x} \\ Q \frac{\partial ( \vec{u} \cdot \vec{{w}^{2}} )}{\partial y} & Q \frac{\partial ( \vec{u} \cdot \vec{{w}^{3}} )}{\partial y} & Q \frac{\partial ( \vec{u} \cdot \vec{{w}^{4}} )}{\partial y} \\ Q \frac{\partial ( \vec{u} \cdot \vec{{w}^{2}} )}{\partial z} & Q \frac{\partial ( \vec{u} \cdot \vec{{w}^{3}} )}{\partial z} & Q \frac{\partial ( \vec{u} \cdot \vec{{w}^{4}} )}{\partial z} \\ Q \frac{\partial \vec{u}}{\partial {θ}_{1}} \cdot \vec{{w}^{2}} & Q \frac{\partial \vec{u}}{\partial {θ}_{1}} \cdot \vec{{w}^{3}} & Q \frac{\partial \vec{u}}{\partial {θ}_{1}} \cdot \vec{{w}^{4}} \\ ⋮ & ⋮ & ⋮ \\ Q \frac{\partial \vec{u}}{\partial {θ}_{N}} \cdot \vec{{w}^{2}} & Q \frac{\partial \vec{u}}{\partial {θ}_{N}} \cdot \vec{{w}^{3}} & Q \frac{\partial \vec{u}}{\partial {θ}_{N}} \cdot \vec{{w}^{4}}\end{matrix} ] \times \{ \begin{matrix}\frac{\partial ϵ}{\partial Q} \\ \frac{\partial ϵ}{\partial x} \\ \frac{\partial ϵ}{\partial y} \\ \frac{\partial ϵ}{\partial z} \\ \frac{\partial ϵ}{\partial {S}_{α}}\end{matrix}$$

Expression (10) is a propagation function, called adjoint propagation function, of the evolution function. Backpropagation involves backpropagating the errors, respectively explained according to the following expressions:

### Evolution of the Charge of the Electron Cloud (Sub-Step 131)

$$− \frac{d}{d t} ( \frac{\partial ϵ}{\partial Q} ) = − \frac{1}{τ} \frac{\partial ϵ}{\partial Q} + {\sum }_{α} \frac{\partial ϵ}{\partial {s}_{α}} ( \vec{u} \cdot \vec{{w}^{α}} ) \qquad ( 20 )$$

### Position of the Electron Cloud (Sub-Step 132)

$$− \frac{d}{d t} ( \frac{\partial ϵ}{\partial x} ) = ( \frac{\partial {u}_{x}}{\partial x} \cdot \frac{\partial ϵ}{\partial x} + \frac{\partial {u}_{y}}{\partial x} \cdot \frac{\partial ϵ}{\partial y} + \frac{\partial {u}_{z}}{\partial x} \cdot \frac{\partial ϵ}{\partial z} ) + Q {\sum }_{α} \frac{\partial ( \vec{u} \cdot \vec{{w}^{α}} )}{\partial x} \cdot \frac{\partial ϵ}{\partial {S}_{α}} \qquad ( 30 )$$

$$− \frac{d}{d t} ( \frac{\partial ϵ}{\partial y} ) = ( \frac{\partial {u}_{x}}{\partial y} \cdot \frac{\partial ϵ}{\partial x} + \frac{\partial {u}_{y}}{\partial y} \cdot \frac{\partial ϵ}{\partial y} + \frac{\partial {u}_{z}}{\partial y} \cdot \frac{\partial ϵ}{\partial z} ) + Q {\sum }_{α} \frac{\partial ( \vec{u} \cdot \vec{{w}^{α}} )}{\partial y} \cdot \frac{\partial ϵ}{\partial {S}_{α}} \qquad ( 31 )$$

$$− \frac{d}{d t} ( \frac{\partial ϵ}{\partial z} ) = ( \frac{\partial {u}_{x}}{\partial z} \cdot \frac{\partial ϵ}{\partial x} + \frac{\partial {u}_{y}}{\partial z} \cdot \frac{\partial ϵ}{\partial y} + \frac{\partial {u}_{z}}{\partial z} \cdot \frac{\partial ϵ}{\partial z} ) + Q {\sum }_{α} \frac{\partial ( \vec{u} \cdot \vec{{w}^{α}} )}{\partial z} \cdot \frac{\partial ϵ}{\partial {S}_{α}} \qquad ( 32 )$$

### Parameter Vector (Sub-Step 133)

$$− \frac{d}{d t} ( \frac{\partial ϵ}{\partial {θ}_{n}} ) = ( \frac{\partial {u}_{x}}{\partial {θ}_{n}} \cdot \frac{\partial ϵ}{\partial x} + \frac{\partial {u}_{y}}{\partial {θ}_{n}} \cdot \frac{\partial ϵ}{\partial y} + \frac{\partial {u}_{z}}{\partial {θ}_{n}} \cdot \frac{\partial ϵ}{\partial z} + Q {\sum }_{α} \frac{\partial ϵ}{\partial {S}^{α}} \frac{\partial \vec{u}}{\partial {θ}_{n}} \cdot {\vec{w}}^{α} ) + \frac{\partial ϵ}{\partial Q} \frac{Q \partial τ}{{τ}^{2} \partial {θ}_{n}} \qquad ( 40 )$$

Sub-steps 131 to 133 are implemented by successive integration, according to time steps dt as described with reference to the propagation step, according to the following expressions:

$$\frac{\partial ϵ}{\partial Q} ( T − d t ) = \frac{\partial ϵ}{\partial Q} ( T ) − {\int }_{T − d t}^{T} ( − \frac{1}{τ ( r )} \frac{\partial ϵ}{\partial Q} + {\sum }_{α} \frac{\partial ϵ}{\partial {S}_{α}} ( \vec{u ( r )} \cdot \vec{{W}^{α} ( r ) )} ) dt \qquad ( 21 )$$

$$\frac{\partial ϵ}{\partial x} ( T − d t ) = \frac{\partial ϵ}{\partial x} ( T ) − {\int }_{T − d t}^{T} ( \frac{\partial {u}_{x}}{\partial x} \cdot \frac{\partial ϵ}{\partial x} + \frac{\partial {u}_{y}}{\partial x} \cdot \frac{\partial ϵ}{\partial y} + \frac{\partial {u}_{z}}{\partial x} \cdot \frac{\partial ϵ}{\partial z} ) + Q {\sum }_{α} \frac{\partial ( \vec{u} . \vec{{w}^{α}} )}{\partial x} \frac{\partial ϵ}{\partial {S}_{α}} d t \qquad ( 33 )$$

$$\frac{\partial ϵ}{\partial y} ( T − d t ) = \frac{\partial ϵ}{\partial y} ( T ) − {\int }_{T − d t}^{T} ( \frac{\partial {u}_{x}}{\partial y} \cdot \frac{\partial ϵ}{\partial x} + \frac{\partial {u}_{y}}{\partial y} \cdot \frac{\partial ϵ}{\partial y} + \frac{\partial {u}_{z}}{\partial x} \cdot \frac{\partial ϵ}{\partial z} ) + Q {\sum }_{α} \frac{\partial ( \vec{u} . \vec{{w}^{α}} )}{\partial y} \frac{\partial ϵ}{\partial {S}_{α}} d t \qquad ( 34 )$$

$$\frac{\partial ϵ}{\partial z} ( T − d t ) = \frac{\partial ϵ}{\partial z} ( T ) − {\int }_{T − d t}^{T} ( \frac{\partial {u}_{x}}{\partial z} \cdot \frac{\partial ϵ}{\partial x} + \frac{\partial {u}_{y}}{\partial z} \cdot \frac{\partial ϵ}{\partial y} + \frac{\partial {u}_{z}}{\partial z} \cdot \frac{\partial ϵ}{\partial z} ) + Q {\sum }_{α} \frac{\partial ( \vec{u} . \vec{{w}^{α}} )}{\partial z} \frac{\partial ϵ}{\partial {S}_{α}} d t \qquad ( 35 )$$

$$\frac{\partial ϵ}{\partial {θ}_{n}} ( T − d t ) = \frac{\partial ϵ}{\partial {θ}_{n}} ( T ) − {\int }_{T − d t}^{T} ( \frac{\partial {u}_{x}}{\partial {θ}_{n}} \cdot \frac{\partial ϵ}{\partial x} + \frac{\partial {u}_{y}}{\partial {θ}_{n}} \cdot \frac{\partial ϵ}{\partial y} + \frac{\partial {u}_{z}}{\partial {θ}_{n}} \cdot \frac{\partial ϵ}{\partial z} + Q {\sum }_{α} \frac{\partial ϵ}{\partial {S}^{α}} \frac{\partial \vec{u}}{\partial {θ}_{n}} \cdot {\vec{w}}^{α} + \frac{\partial ϵ}{\partial Q} \frac{Q \partial τ}{{τ}^{2} \partial {θ}_{n}} ) dt \qquad ( 41 )$$

The following is known:

$$Δ {S}_{α} = {\hat{S}}_{α} − {S}_{α} = \frac{\partial ϵ}{\partial {S}_{α}} .$$

Expressions (21), (33), (34), (35) and (41) allow backpropagation between the instants t₁ and t₀, which are known because they are defined during the propagation. These expressions can be combined with:

$$\frac{\partial ϵ}{\partial Q} = {\sum }_{α} \frac{\partial ϵ}{\partial {S}_{α}} \frac{\partial {S}_{α}}{\partial Q} = {\sum }_{α} Δ {S}_{α} \frac{\partial {S}_{α}}{\partial Q} \qquad ( 22 )$$

$$\frac{\partial ϵ}{\partial x} = {\sum }_{α} \frac{\partial ϵ}{\partial {S}_{α}} \frac{\partial {S}_{α}}{\partial x} = {\sum }_{α} Δ {S}_{α} \frac{\partial {S}_{α}}{\partial x} \qquad ( 36 )$$

$$\frac{\partial ϵ}{\partial y} = {\sum }_{α} \frac{\partial ϵ}{\partial {S}_{α}} \frac{\partial {S}_{α}}{\partial y} = {\sum }_{α} Δ {S}_{α} \frac{\partial {S}_{α}}{\partial y} \qquad ( 37 )$$

$$\frac{\partial ϵ}{\partial z} = {\sum }_{α} \frac{\partial ϵ}{\partial {S}_{α}} \frac{\partial {S}_{α}}{\partial z} = {\sum }_{α} Δ {S}_{α} \frac{\partial {S}_{α}}{\partial z} \qquad ( 38 )$$

$$\frac{\partial ϵ}{\partial {θ}_{n}} = {\sum }_{α} Δ {S}_{α} \frac{\partial {S}_{α}}{\partial {θ}_{n}} = Δ {S}_{α} \frac{\partial {S}_{α}}{\partial {θ}_{n}} \qquad ( 42 )$$

This yields expressions that allow the backpropagations to be carried out, expressing the dependence of the signals S_{α} on the various parameters: those of the event Q, x, y, z and those of the detector θ:

### Evolution of the Charge of the Electron Cloud

$$− \frac{\partial {\dot{S}}^{α}}{\partial Q} = − \frac{1}{τ} \frac{\partial {S}^{α}}{\partial Q} + \vec{u} \cdot \vec{{w}^{α}} \qquad ( 23 )$$

### Position of the Electron Cloud

$$− \frac{\partial {\dot{S}}^{α}}{\partial x} = ( \frac{\partial {u}_{x}}{\partial x} \cdot \frac{\partial {S}^{α}}{\partial x} + \frac{\partial {u}_{y}}{\partial x} \cdot \frac{\partial {S}^{α}}{\partial y} + \frac{\partial {u}_{z}}{\partial x} \cdot \frac{\partial {S}^{α}}{\partial z} ) + Q \frac{\partial ( \vec{u} \cdot \vec{{w}^{α}} )}{\partial x} \qquad ( 39 )$$

$$− \frac{\partial {\dot{S}}^{α}}{\partial y} = ( \frac{\partial {u}_{x}}{\partial y} \cdot \frac{\partial {S}^{α}}{\partial x} + \frac{\partial {u}_{y}}{\partial y} \cdot \frac{\partial {S}^{α}}{\partial y} + \frac{\partial {u}_{z}}{\partial y} \cdot \frac{\partial {S}^{α}}{\partial z} ) + Q \frac{\partial ( \vec{u} \cdot \vec{{w}^{α}} )}{\partial x} \qquad ( {39}^{′} )$$

$$− \frac{\partial {\dot{S}}^{α}}{\partial z} = ( \frac{\partial {u}_{x}}{\partial z} \cdot \frac{\partial {S}^{α}}{\partial x} + \frac{\partial {u}_{y}}{\partial z} \cdot \frac{\partial {S}^{α}}{\partial y} + \frac{\partial {u}_{z}}{\partial z} \cdot \frac{\partial {S}^{α}}{\partial z} ) + Q \frac{\partial ( \vec{u} \cdot \vec{{w}^{α}} )}{\partial x} \qquad ( {39}^{″} )$$

### Parameter Vector

$$− \frac{\partial {\dot{S}}^{α}}{\partial {θ}_{n}} = ( \frac{\partial {u}_{x}}{\partial {θ}_{n}} \cdot \frac{\partial {S}^{α}}{\partial x} + \frac{\partial {u}_{y}}{\partial {θ}_{n}} \cdot \frac{\partial {S}^{α}}{\partial y} + \frac{\partial {u}_{z}}{\partial {θ}_{n}} \cdot \frac{\partial {S}^{α}}{\partial z} + Q \frac{\partial \vec{u}}{\partial {θ}_{n}} \cdot {\vec{w}}^{α} ) + \frac{\partial {S}^{α}}{\partial Q} \frac{Q \partial τ}{{τ}^{2} \partial {θ}_{n}} \qquad ( 43 )$$

### Updating Step

During step 140, the initial state X₀ is updated. This step involves determining the deviations ΔQ (sub-step 141), Δr(Δr=(Δx,Δy,Δz)) (sub-step 142), Δθ (formed by correction terms Δθₙ) (141), (sub-step 143) for each interaction.

The update can be carried out using the diagonal Gauss-Newton method: see expressions (50) to (54).

$$Δ Q = \frac{\frac{\partial ϵ}{\partial Q} ( t 0 )}{{\sum }_{α} \frac{\partial {S}_{α}^{2}}{\partial Q}} \qquad ( 50 )$$

$$Δ x = \frac{\frac{\partial ϵ}{\partial x} ( t 0 )}{{\sum }_{α} \frac{\partial {S}_{α}^{2}}{\partial x}} \qquad ( 51 )$$

$$Δ y = \frac{\frac{\partial ϵ}{\partial y} ( t 0 )}{{\sum }_{α} \frac{\partial {S}_{α}^{2}}{\partial y}} \qquad ( 52 )$$

$$Δ z = \frac{\frac{\partial ϵ}{\partial z} ( t 0 )}{{\sum }_{α} \frac{\partial {S}_{α}^{2}}{\partial z}} \qquad ( 53 )$$

$$Δ {θ}_{n} = \frac{\frac{\partial ϵ}{\partial {θ}_{n}}}{{\sum }_{α} \frac{\partial {S}_{α}^{2}}{\partial {θ}_{n}}} \qquad ( 54 )$$

During updating,

$${X}_{0} = {X}_{0} + Δ {X}_{0} \qquad ( 60 )$$

Thus, in this example: x₀←x₀+Δx; y₀←y₀+Δy₀; Z₀+z₀+Δz₀; θₙ←θₙ+Δθₙ (61)

During a step 150, the correction terms Δθₙ defined when implementing the method are taken into account for several interactions, typically several hundred interactions, in order to form an average correction vector θ̅. The average correction vector is formed from an average of the parameters θₙ defined for the interactions.

During this step, criteria other than an average of the correction terms θₙ can be used to form the correction vector θ̅, for example, a median.

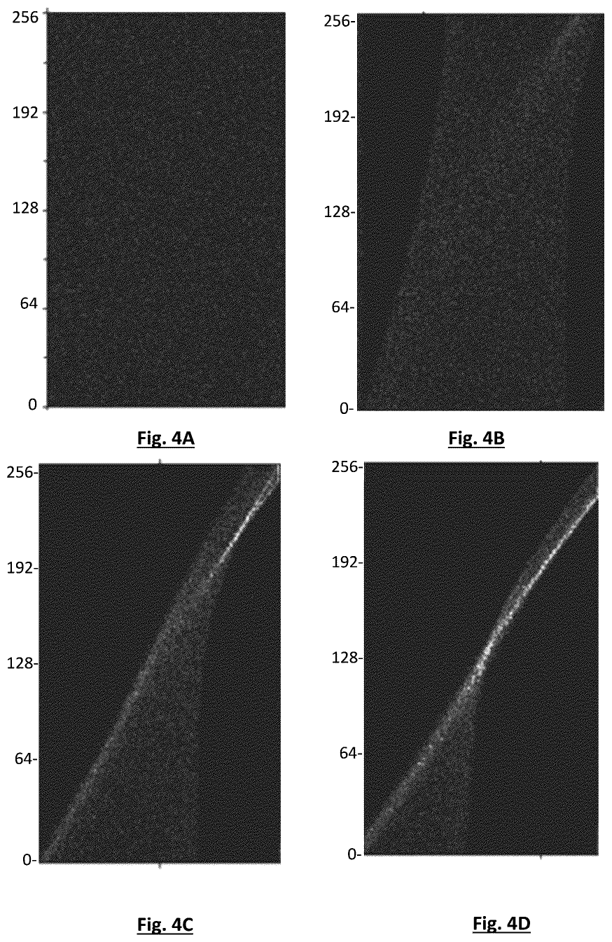

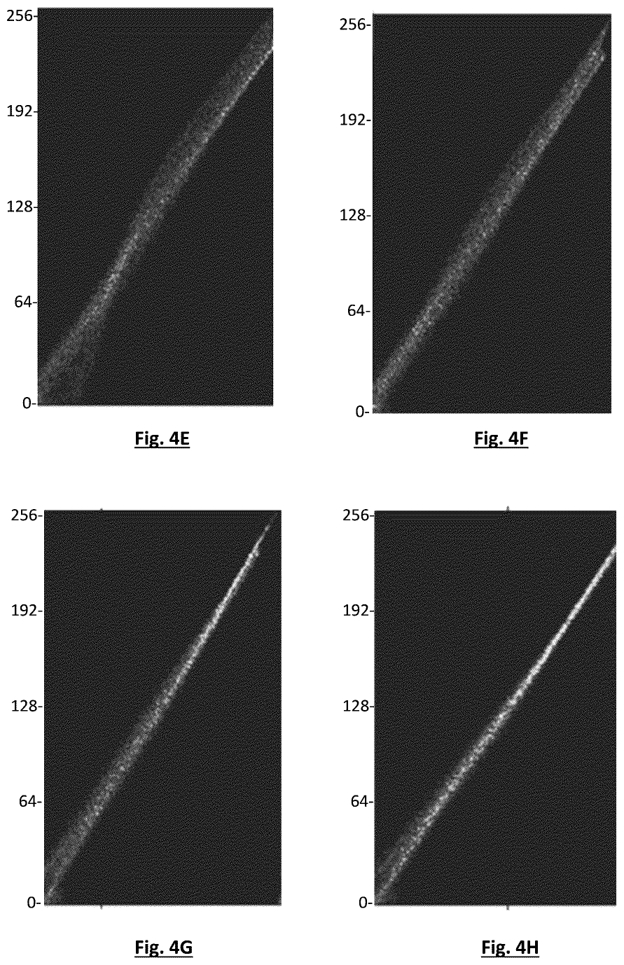

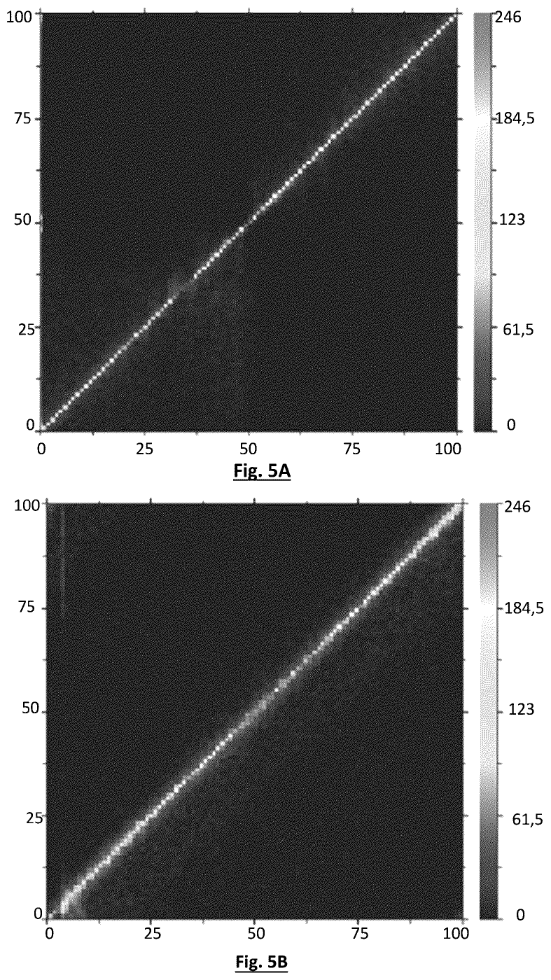

The method described above has been implemented. FIGS. 4A to 4H show the estimate of the depth of interaction in the detector, for various modelled interactions, for eight successive iterations. Each point corresponds to an interaction. The abscissa axis corresponds to the modelled depths, while the ordinate axis corresponds to the depths estimated by the algorithm. The initial depths are selected randomly (see FIG. 4A). After eight iterations, it can be seen that the estimated depths are consistent with the modelled depths.

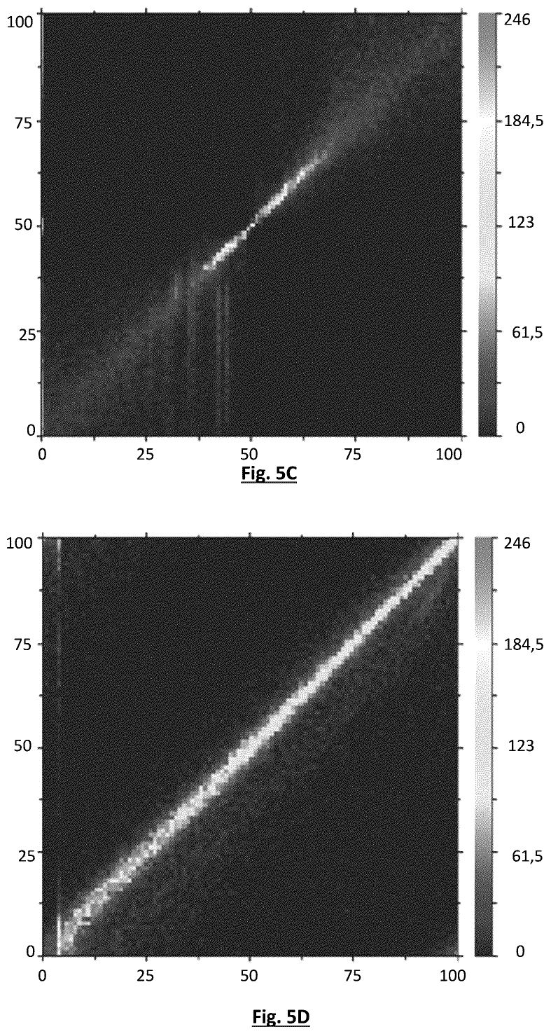

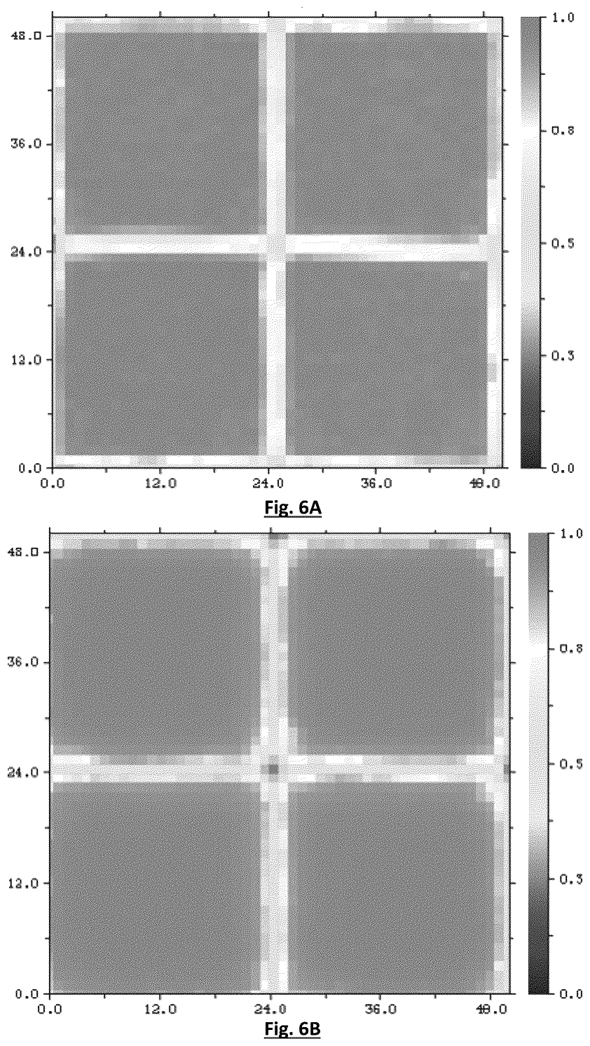

FIGS. 5A and 5B respectively show an estimate of the interaction positions along an X axis, parallel to the anodes, and along the depth (Z axis). These figures were obtained by taking into account 32,768 photon interactions with 122 keV of energy on a detector comprising 2×2 anodes.

FIGS. 5C and 5D are equivalent to FIGS. 5A and 5B, but take into account realistic noise for 122 keV of energy.

During another series of tests, the CIE (Charge Induction Efficiency), which represents the ratio, normalised to 1, between the charge collected and the charge deposited by a photon during an interaction, was simulated. A detector formed by 2×2 anodes was considered. FIG. 6A shows a CIE measured by scanning the detector with a collimated beam, with a beam energy of 122 keV. FIG. 6B shows a simulated CIE implementing the invention. It can be seen that the simulation is consistent with the measurements.

The method thus allows a precise estimate to be provided of the response of a detector.

It is also possible to estimate the response of a detector using a supervised learning neural network type algorithm. The use of such an algorithm requires less computing power than that of the method that is the subject matter of the invention.

However, a neural network requires a supervised learning phase. The invention referred to above can be used to carry out supervised learning of a neural network, replacing tedious experimental tests because they require control of the position of the interactions in the sensor material.

The invention allows interactions to be generated at any point in the detector and the detection signal to be estimated on one or more anodes. Therefore, it can be used to define learning sets, associating data linked to an interaction in the detector (position in the detector and energy) and the signals induced on various anodes.

The neural network can be of the multilayer perceptron type, comprising:
as an input layer: at least one feature of the signal from the anode that collected the maximum signal (collecting anode) and from the anodes adjacent thereto; for example, the maximum signal from the collecting anode and the maximum signal from anodes adjacent to the collecting anode can be taken into account;
as the output layer: the position of the interaction in the detector, in two or three dimensions, as well as the charge released during the interaction: thus, the output layer is made up of 3 or 4 nodes.

Between the input layer and the output layer, the neural network can comprise, for example, 3 interconnected layers, with 16 nodes per layer. Such a neural network allows correct modelling of a detector.

The input layer advantageously comprises, for each anode, a feature that is normalised by the same feature of the anode that collected the maximum signal. The feature can be a maximum amplitude or an amplitude of a transient signal. In this case, the output layer is multiplied by the normalisation term so as to estimate the energy. An example of a neural network is described, for example, in the publication by Yang et al., entitled, “Joint estimation of interaction position and energy deposition in semiconductor SPECT imaging sensors using fully connected neural network”. In this publication, the neural network undergoes supervised learning, using experimental data.

Such a neural network can be easily encoded on a compact electronic board, of the FPGA (Field Programmable Gate Array) type. The advantage is that a relatively simple neural network can be used to model the detector response, and no complex components are required to implement it. The learning for the neural network is carried out easily, in particular by simulations, using the method described above.

Although it has been described with reference to an X-ray or gamma-ray photon detector, the invention can be applied to other types of ionising radiation, for example, α, β- or neutrons.

1.-9. (canceled)

10. A method for estimating a signal measured on a pixel of a detector, the detector comprising a plurality of electrodes, forming pixels, connected to a detector material, the detector material being a semiconductor, each electrode being configured to collect charge carriers moving, through the detector material, under the effect of an electric field, following an interaction of ionising radiation in the detector material, the method comprising:
irradiating the detector with X-ray or gamma-ray photons, so as to generate interactions in the detector material, with each interaction forming a detection signal (S_{α}) measured by at least one electrode;
associating, for various detected interactions, a state vector, comprising at least a position, a charge, and the detection signal, with the state vector transitioning from an initial state, when the interaction occurs, to a final state, when the electrons generated by the interaction are collected by at least one electrode;
wherein the method comprises, for each detected interaction:
(i) initialising the initial state vector;
(ii) implementing, based on the initial state, or on an initial state resulting from a previous iteration, a charge carrier propagation model in the semiconductor material, in order to estimate the state vector in the final state, with the propagation model being based on a parameter vector, the parameter vector parameterising at least one transport property of the charge carriers through the detector material, towards the electrodes;
(iii) computing an error, representing a difference between the estimated detection signal state vector in the final state and the measured detection signal;
(iv) backpropagating a gradient of the error from the final state to the initial state, with the gradient of the error being computed relative to at least one term of the state vector, and relative to a plurality of parameters of the parameter vector;
(v) updating the state vector, at the initial state, and the parameter vector, and repeating steps (ii) to (v) until a criterion for stopping the iterations is met;
and wherein:
steps (i) to (v) are implemented by a processing unit connected to the detector.

11. The method according to claim 10, wherein:
steps (i) to (v) are implemented for various interactions, so as to update the parameter vector each time steps (i) to (v) are implemented;
the parameter vector is then updated by combining the parameter vectors updated during each interaction.

12. The method according to claim 10, wherein the detector material is discretised into voxels, and wherein the parameter vector comprises, for each voxel, a transport property for the charge carriers in the detector.

13. The method according to claim 12, wherein the transport property for charge carriers comprises:
a value of the electric field; and/or
a gradient of the electric field in at least one direction; and/or
a value of a divergence of the electric field; and/or
a probability of trapping in the voxel.

14. The method according to claim 11, wherein:
for each interaction, the time between the initial state and the final state is discretised into time steps;
step (ii) comprises a digital integration of an evolution function, with the evolution function representing
a temporal evolution of the position and of the charge of the charge carriers, and;
an evolution of each detection signal;
wherein the digital integration is successively carried out between each time step, between the initial state and the final state.

15. The method according to claim 14, wherein step (iv) comprises a digital integration of an adjoint propagation equation, translating a temporal evolution of the gradient of the error, with the digital integration being successively carried out between each time step, between the final state and the initial state.

16. A method for training a supervised artificial intelligence algorithm, configured to simulate a response of a detector;
wherein the detector comprises a plurality of electrodes, forming pixels, connected to a semiconductor material, each pixel being configured to collect charge carriers moving, through the semiconductor material, under the effect of an electric field, following an interaction of ionising radiation in the semiconductor material,
wherein the method comprises:
a) defining a position of an interaction in the detector and energy released during said interaction;
b) estimating a detection signal measured by at least one electrode of the detector, by implementing the steps of the method according to claim 10;
c) repeating steps a) and b) so as to form a database connecting, for each defined interaction, the measured signal to at least one pixel;
d) using the database to carry out supervised learning of the artificial intelligence algorithm.

17. The method according to claim 16, wherein the artificial intelligence algorithm is of the multilayer perceptron type.

18. A detector, comprising a plurality of electrodes, forming pixels, connected to a semiconductor material, with each pixel being configured to collect charge carriers moving, through the semiconductor material, under the effect of an electric field, following an interaction of ionising radiation in the semiconductor material;
wherein the detector is connected to a processing unit configured to implement steps (i) to (v) of the method according to claim 10.

19. A detector, comprising a plurality of electrodes, forming pixels, connected to a semiconductor material, with each pixel being configured to collect charge carriers moving, through the semiconductor material, under the effect of an electric field, following an interaction of ionising radiation in the semiconductor material;
wherein the detector is connected to a processing unit configured to estimate energy released by the interaction and/or a position of the interaction
wherein the processing unit implements a supervised artificial intelligence algorithm that is trained according to the method of claim 16.
